(19) United States
(12) Patent Application Publication
(10) Pub. No.: US 2010/0078133 A1
(43) Pub. Date: Apr. 1, 2010

(54) Low Resistance Loading Apparatus

(76) Inventor: Fu-Chuan HUANG, Chiayi County (TW)

Correspondence Address: FRENKEL & ASSOCIATES, 3975 UNIVERSITY DR., STE. 330, FAIRFAX, VA, 22030, US

(21) Appl. No.: 12/238,506

(22) Filed: Sep. 26, 2008

(51) Int. Cl. B32B 37/00

(52) U.S. Cl. 156/538

(57) ABSTRACT

A low resistance loading apparatus includes a rotary means and an ejection head. The rotary means includes a rotary bar, a turnable handle and a coupling element coupled on the rotary bar. The rotary bar is an elongate rod with one side fastened to the turnable handle to turn the rotary bar. The coupling element has a coupling ring at one side to couple the ejection head. The ejection head has an air intake duct at one side to receive high pressure air from outside and a nozzle at another side. The nozzle has a plurality of ejection vents to evenly eject the high pressure air.

### FIELD OF THE INVENTION

The present invention relates to a loading apparatus and particularly to a low resistance loading apparatus to facilitate conveying of a thermo-shrink film in labeling machines.

### BACKGROUND OF THE INVENTION

Bonding labels to containers usually is performed automatically through a labeling machine to save process time and manpower. Refer to FIG. 1 for a conventional feeding means A10 of the labeling machine. The feeding means A10 mainly includes a chassis A11, a rotary tray A12 and a roll of thermo-shrink film A13 wound on the rotary tray A12. The rotary tray A12 is mounted onto the chassis A11 and can be rotated thereon. When in use, the thermo-shrink film A13 is drawn and turns the rotary tray A12. Such an operation has drawbacks, notably:

1. As the thermo-shrink film A13 is wound on the rotary tray A12 in a roll, if the winding is not being properly done or the film is over weighed, the thermo-shrink film A13 could become sticky between layers. As a result, drawing of the film could be hindered, and operation of the chassis A11 suffers.

2. The thermo-shrink film A13 often becomes unsmooth after being wound in the roll fashion for a period of time. Hence when it is conveyed through the feeding means A10 to the labeling machine, an undesirable labeling result could incur. An additional blowing and trimming process usually is needed to remedy this problem.

### SUMMARY OF THE INVENTION

Therefore, the primary object of the present invention is to provide a low resistance loading apparatus to facilitate conveying of a thermo-shrink film in labeling machines to improve operation efficiency.

The loading apparatus according to the invention includes a rotary means and an ejection head. The rotary means includes a rotary bar, a turnable handle and a coupling element. The rotary bar is an elongate rod with one side fastened to the turnable handle to turn the rotary bar. The coupling element is coupled on the rotary bar and has a coupling ring at one side thereof to couple the ejection head. The ejection head has an air intake duct at one side to receive high pressure air or compressed air from outside and a nozzle at another side. The nozzle has a plurality of ejection vents to evenly eject the high pressure air received through the air intake duct.

The foregoing, as well as additional objects, features and advantages of the invention will be more readily apparent from the following embodiments with reference to the accompanying drawings. The embodiments discussed below serve only for illustrative purpose and are not the limitation of the invention.

### BRIEF DESCRIPTION OF THE DRAWINGS

FIG. 1 is a schematic view of a conventional technique in an operating condition.

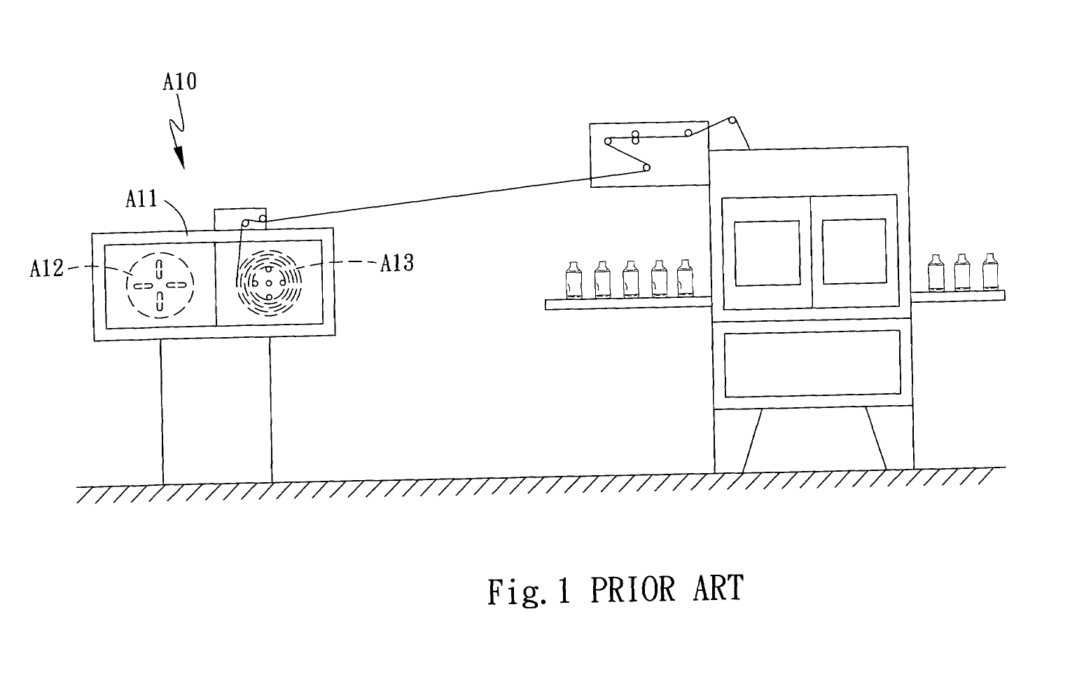

FIG. 2 is an exploded view of the invention.

FIG. 3 is a perspective view of the invention.

FIG. 4 is a perspective view of an embodiment of the invention in a use condition.

FIG. 5 is a schematic view of an embodiment of the invention in an operating condition.

FIG. 6 is a perspective view of an embodiment of the invention adopted on a labeling machine.

FIG. 7 is a schematic view of another embodiment of the invention.

### DETAILED DESCRIPTION OF THE PREFERRED EMBODIMENTS

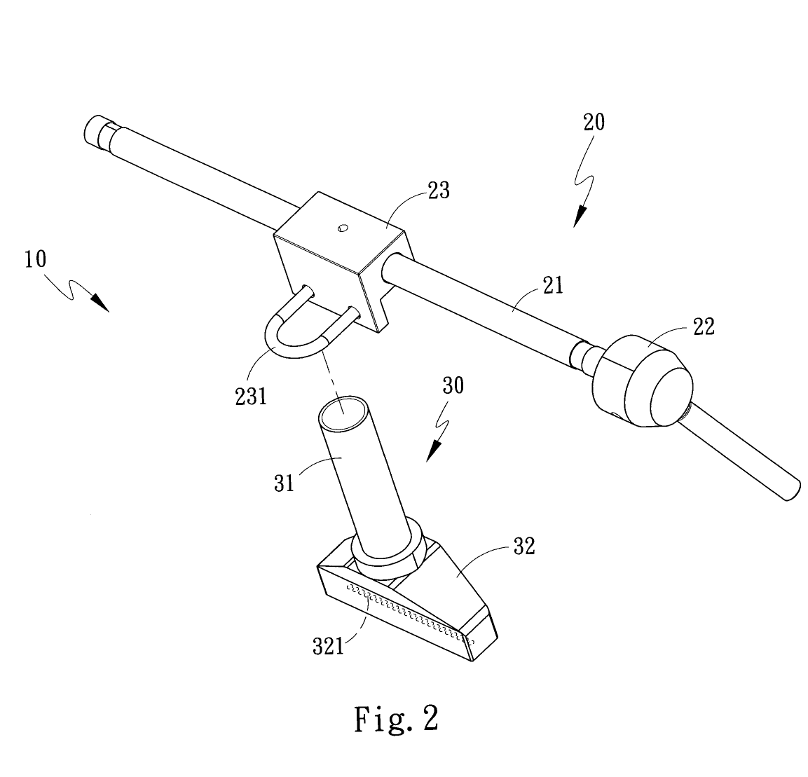

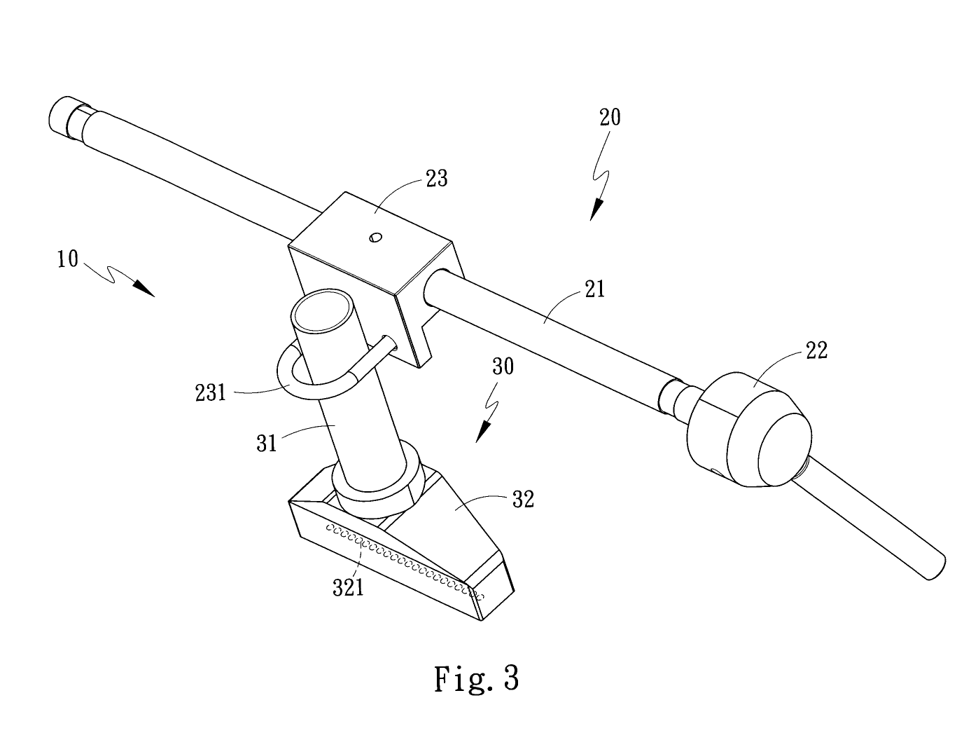

Please refer to FIGS. 2 and 3, the present invention provides a low resistance loading apparatus 10 which includes a rotary means 20 and an ejection head 30.

The rotary means 20 includes a rotary bar 21, a turnable handle 22 and a coupling element 23. The rotary bar 21 is an elongate rod with one side fastened to the turnable handle 22 for turning the rotary bar 21. The coupling element 23 is coupled on the rotary bar 21 and has a coupling ring 231 at one side to couple the ejection head 30. The ejection head 30 has an air intake duct 31 at one side to receive high pressure air or compressed air from outside and a nozzle 32 at another side. The nozzle 32 has a plurality of ejection vents 321 formed thereon to evenly eject the high pressure air. At least one ejection head 30 is provided in the invention.

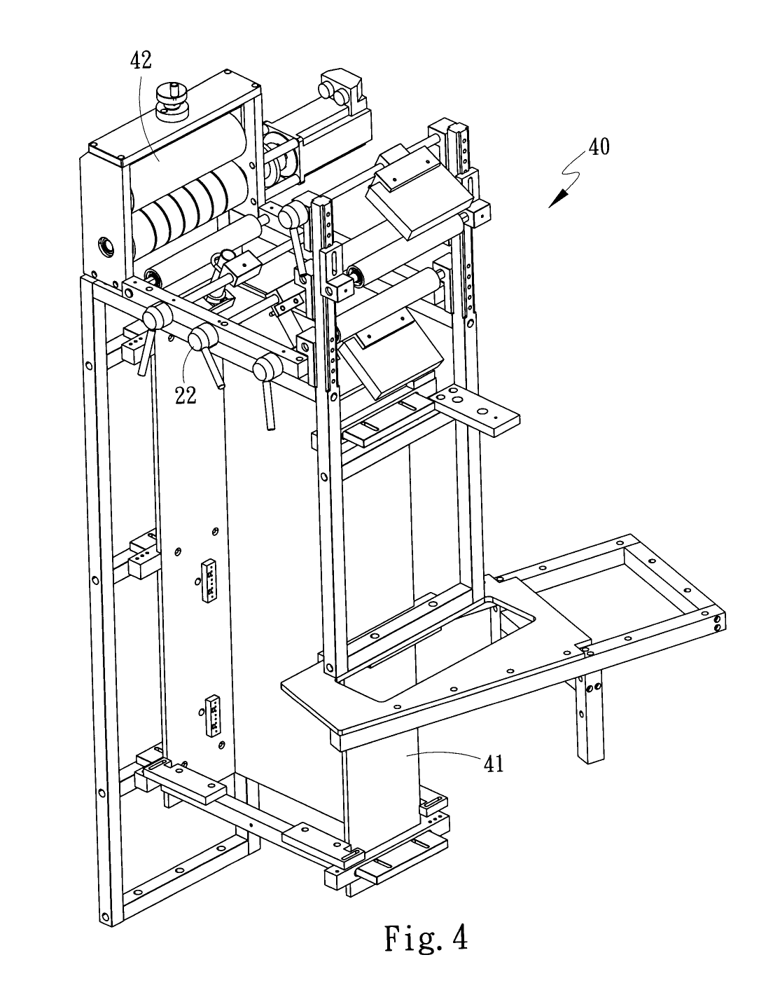

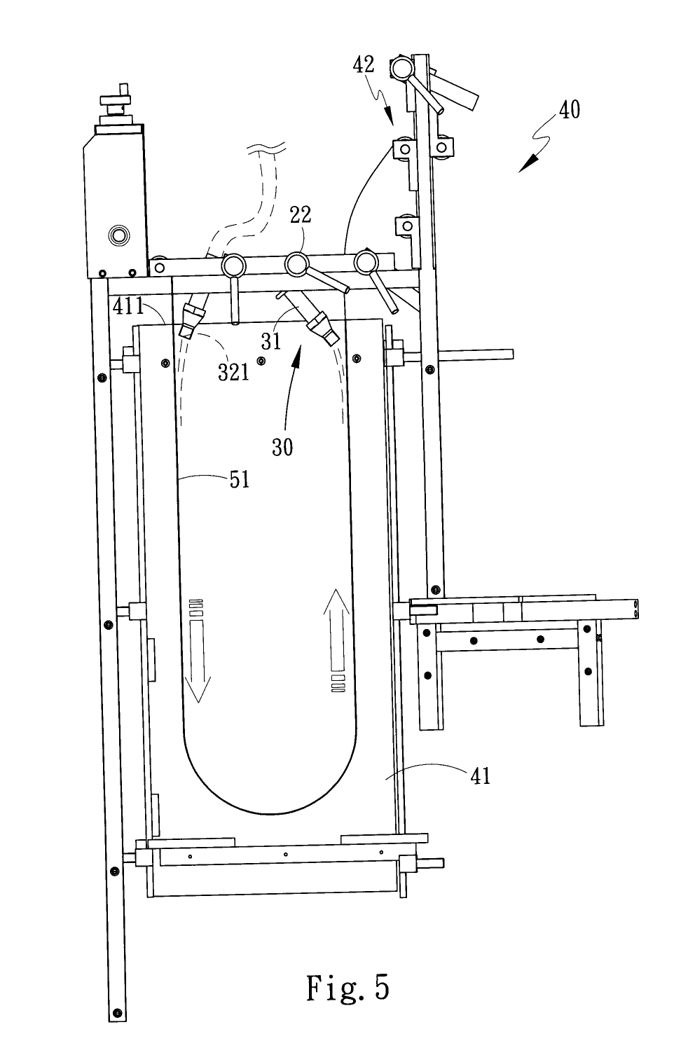

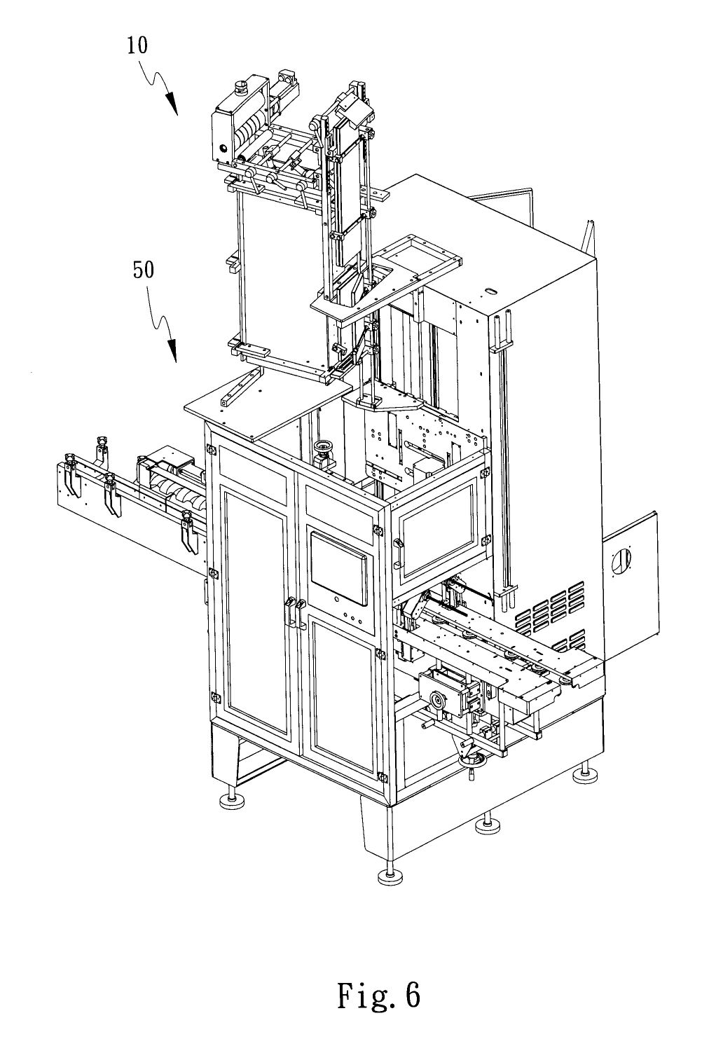

Referring to FIGS. 4, 5 and 6, when the low resistance loading apparatus 10 is in use, it is installed on one side of a feeding means 40 of a thermo-shrink film 51 of a labeling machine 50. The feeding means 40 includes a loading tank 41, a plurality of loading apparatus 10 and a plurality of conveying roller sets 42. The loading tank 41 is hollow and has an opening 411 at one side. The loading apparatus 10 is located at the one side of the loading tank 41 where the opening 411 is formed to smooth the thermo-shrink film 51 by the high pressure air ejected through the air intake duct 31 and ejection vents 321 of the ejection head 30. The angle of the ejection head 30 can be adjusted through the turnable handle 22 to achieve required effect. The conveying roller sets 42 are located at two sides of the opening 411 to smoothly convey the thermo-shrink film 51 into and outside the loading tank 41. The number of the conveying roller sets 42 is set according to requirement.

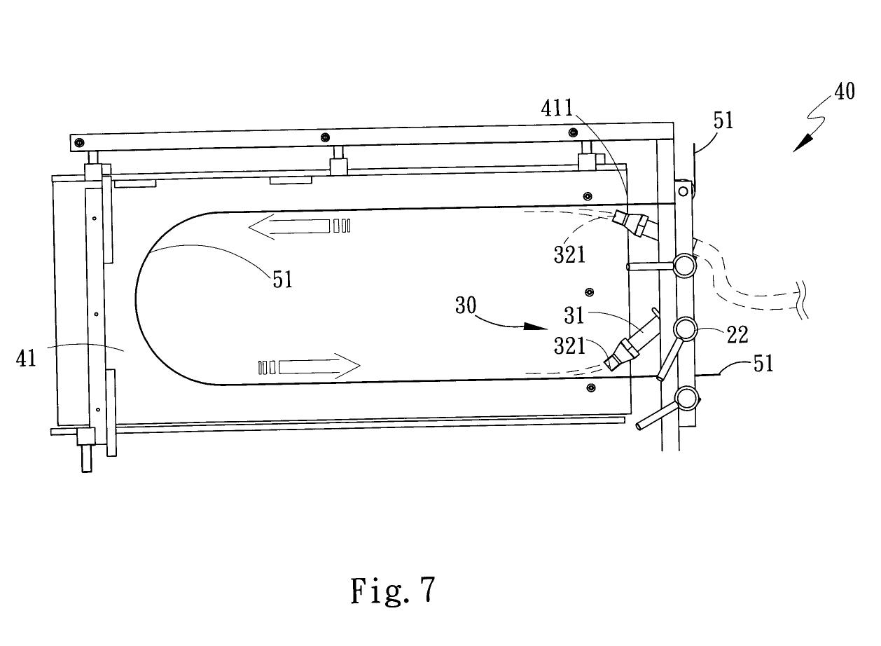

Refer to FIG. 7 for another embodiment of the invention. The feeding means 40 may be installed in a transverse manner. The thermo-shrink film 51 is fed from one side of the feeding means 40. The hollow loading tank 41 has the opening 411 at one side. The thermo-shrink film 51 is smoothed by the high pressure air ejected through the air intake duct 31 and ejection vents 321 of the ejection head 30. The angle of the ejection head 30 can be adjusted through the turnable handle 22 to achieve the required effect. The conveying roller sets 42 are located at two sides of the opening 411 to smoothly convey the thermo-shrink film 51 into and outside the loading tank 41.

What is claimed is:

1. A low resistance loading apparatus, comprising:
a rotary means which includes a rotary bar, a turnable handle and a coupling element coupled on the rotary bar, the rotary bar being an elongate rod and having one side fastened to the turnable handle to turn the rotary bar, the coupling element having a coupling ring at one side thereof; and
an ejection head which is coupled by the coupling ring and has an air intake duct at one side thereof to receive high pressure air from outside and a nozzle at another side that has a plurality of ejection vents to evenly eject the high pressure air.

2. The low resistance loading apparatus of claim 1, wherein the ejection head is more than one.

3. The low resistance loading apparatus of claim 1 further having a longitudinal loading tank.

4. The low resistance loading apparatus of claim 1 further having a transverse loading tank.
